(19) United States
(12) Patent Application Publication
(10) Pub. No.: US 2015/0338650 A1
(43) Pub. Date: Nov. 26, 2015

(54) LOW-DEFINITION DISPLAY WITH A COMPACT OPTICAL SUPERPOSITION DEVICE AND ASSOCIATED INSTRUMENT SET

(71) Applicants: CONTINENTAL AUTOMOTIVE FRANCE, Toulouse (DE); CONTINENTAL AUTOMOTIVE GMBH, Hannover (DE)

(72) Inventor: Pascal CLOCHARD, Chevreuse (FR)

(73) Assignees: CONTINENTAL AUTOMOTIVE FRANCE, Toulouse (FR); CONTINENTAL AUTOMOTIVE GmbH, Hannover (DE)

(21) Appl. No.: 14/652,916

(22) PCT Filed: Dec. 13, 2013
(86) PCT No.: PCT/EP2013/003766

§ 371 Date: Jun. 17, 2015

(30) Foreign Application Priority Data
Dec. 19, 2012 (FR) 1262298

(51) Int. Cl. G02B 27/01

(52) U.S. Cl. CPC G02B 27/0101; G02B 2027/0141; G02B 2027/0118

(57) ABSTRACT

A display device (1), associated with an instrument set (4), includes a low-definition display (3) and a semi-transparent mirror (2) disposed on an instrument panel, opposite the low-definition display. The device is remarkable in that the semi-transparent mirror is positioned at an angle of more than 45° relative to the low-definition display. An angle of more than 45°, instead of the angle of 45° generally used, reduces the space occupied by the semi-transparent mirror in the direction of the driver's vision. Positioning the semi-transparent mirror at an angle of more than 45° relative to the low-definition display produces a reverse image where the top of the image intended to represent the horizon is nearer than the low portion that is supposed to be nearer. An instrument set (4) incorporating the display device is also described.

The present invention relates to a human-machine interface of the type that may be used in a cockpit of a means of transport such as a motor vehicle or an aircraft. This interface is placed on a dashboard of said means of transport. It relates more specifically to low-definition display systems for motor vehicles which can be used to display an image providing information for users.

A means of transport such as a motor vehicle, for example, may be provided with visual reference frames and human-machine interfaces capable of transmitting information enabling a driver to understand the state of an operating parameter of the vehicle more rapidly and easily. This parameter may, for example, relate to the operating state of a speed controller, or to the exceeding of a reference speed determined by said controller. In any case it forms a useful piece of information for the driver of the vehicle in the context of driving said vehicle.

In the context of driving a vehicle, the human-machine interface delivering the information to the pilot or driver must be clearly visible and comprehensible. The same applies to the instruments.

A display unit usually interacts with a semi-reflective mirror placed at 45° to said display unit.

Low-definition display units of this type may be positioned at different locations on the vehicle dashboard, and in particular in front of the driver, behind the steering wheel where the image of the low-definition display unit can be optically superposed on an instrument set placed behind the steering wheel. The low-definition display unit may also be placed behind and above the steering wheel. This type of location of the instrument set is becoming increasingly common. In this case, the assembly is less compact and has a relatively high thickness, which is incompatible with the usual thickness of these devices. This makes it impossible to fit these two types of instrument sets in the same vehicle.

Optical superposition can be provided using a display unit of sufficiently small size to be placed in a standard device. These display units tend to be of a high-definition type and are usually associated with an instrument set by means of a semi-transparent (and therefore semi-reflective) device. However, this reduced size of the display unit causes difficulties, because the projected image is small and therefore hard to read.

The object of the present invention is to propose a low-definition display unit which can provide a display in front of the steering wheel while being compact, having small overall dimensions, and including a perspective effect.

The display device according to the invention is associated with an instrument set and comprises a low-definition display unit and a semi-transparent mirror placed on the dashboard opposite said low-definition display unit; it is notable in that the semi-transparent mirror lies at an angle of more than 45° to the low-definition display unit. An angle of more than 45°, instead of the 45° angle commonly used, reduces the overall dimensions of the semi-transparent mirror in the driver's viewing direction. The orientation of the semi-transparent mirror at more than 45° relative to the low-definition display unit provides an inverted image in which the top of the image which is supposed to represent the horizon is located nearer to the observer/driver than the low part which is supposed to be closer. This image, in which the part supposed to appear distant is near and the part supposed to appear close is farther away, might interfere with the driver's reading, especially if a perspective effect is desired, and this has led component manufacturers to reject this solution. Surprisingly, however, it has been found that the brain can restore the perspective to the desired position. This correction is facilitated by the fact that the definition of the image is fuzzy. This also makes it feasible to use semi-transparent mirror surfaces which are not flat, notably surfaces with defects, since there are no important optical requirements. The question of whether there is a plurality of focal planes or a continuous variation becomes unimportant with slightly fuzzy images. This is the opposite of a head-up display on the windshield, where the windshield has two curvatures that must be compensated to provide a single focal plane, because the images must be sharp.

According to a particular characteristic, the low-definition display unit has a variable brightness. The low-definition display unit is thus capable of providing much greater brightness than a standard display unit, allowing detection by the driver's eye while the driver is concentrating on the road. If there is no information, the low-definition display unit is switched off. On the other hand, if information has to be provided to the driver, the low-definition display unit or an area of the low-definition display unit becomes brighter than the other display units, thereby alerting the driver.

According to another characteristic, the low-definition display unit is placed behind a steering wheel. This position is more natural for the driver. This position allows the driver to have instinctive reactions, because it provides an immediate understanding of left-right positioning, particularly as regards lane changing, overtaking vehicle alerts, or parking assistance, for example. This is the effect of lateralization.

According to a particular characteristic, the low-definition display unit is horizontal. In the present application, the term “horizontal” denotes a straight line parallel to the driver's axis of vision, which may be inclined relative to the ground. The low-definition display unit is placed horizontally so that the image emitted by the low-definition display unit is not visible to the driver, and does not interfere with his reading.

In a particular arrangement, the angle between the low-definition display unit and the semi-transparent mirror is 71°. This angle enables the thickness of the device to be much smaller.

According to another characteristic, the low-definition display unit is placed above an instrument set. In this case, the image of the low-definition display unit is superposed on the instrument set. The brightness of the low-definition display unit can be adjusted to allow for the brightness of the passenger compartment of the vehicle or of the external environment, notably in the evening with the sun setting in front of the driver, which is the worst case considered.

According to another characteristic, the semi-transparent mirror has a horizontal component of less than 70 mm. This 70 mm horizontal component corresponds to the projection of the semi-transparent mirror on the axis along which the user looks at the instrument set, and must correspond to the size of the shroud, the assembly not exceeding the size of an ordinary instrument set without a display unit.

In a specific arrangement, the low-definition display unit projects an image of trapezoidal shape. This trapezoidal shape resembles the perspective view of the road seen by the driver. Thus this shape depicts the road with a wide part in the foreground (at the bottom of the virtual image) and a narrow part at the rear (at the top of the virtual image). The driver's view then matches that of a road extending into the distance.

According to a specific characteristic, a multi-function display unit is placed behind the semi-transparent mirror. It is possible, for example, to provide a high-definition display unit of the type known as TFT (the English abbreviation for Thin Film Transistor, i.e. field-effect transistor) or of the type known as OLED (the English abbreviation for Organic Light-Emitting Diode, i.e. organic LED), which will be used to complement the low-definition display unit. If the information provided by the instrument set is separated into information from alarms and information from instruments properly speaking (speedometer, gauges, and odometer), then the low-definition display unit is available for the alarms. The multi-function display unit keeps the statutory information, such as the speed, displayed in the area of this display unit. The instrument set, the multi-function display unit and the low-definition display unit can therefore be placed together in an efficient manner, thereby combining the displays and the reactions created in the driver.

The invention also covers an instrument set housing a display device as described above, said instrument set being remarkable in that the semi-transparent mirror forms its outer part which is visible to the driver. This makes it easier to integrate the display device with the instrument set and with the dashboard.

Advantageously, the low-definition display unit is placed in a shroud of the instrument set. This position enables the low-definition display unit to be protected from the sun, thereby avoiding reflections that might be troublesome for the driver. This position also makes it possible to facilitate the air circulation over the printed circuit on which are located the components of the low-definition display unit and the LEDs (the English abbreviation for Light-Emitting Diodes) of which it is composed. In the conventional case of a domed area located on the upper part of the shroud, air circulation occurs fairly naturally. It is possible to provide a suitable design so as to provide openings for the upward discharge of warm air after cool air has been drawn in from below, the air circulation taking place either by natural convection or in an assisted manner. Other advantages may also be apparent to persons skilled in the art from a reading of the examples below, illustrated by the appended drawings, provided for illustrative purposes.

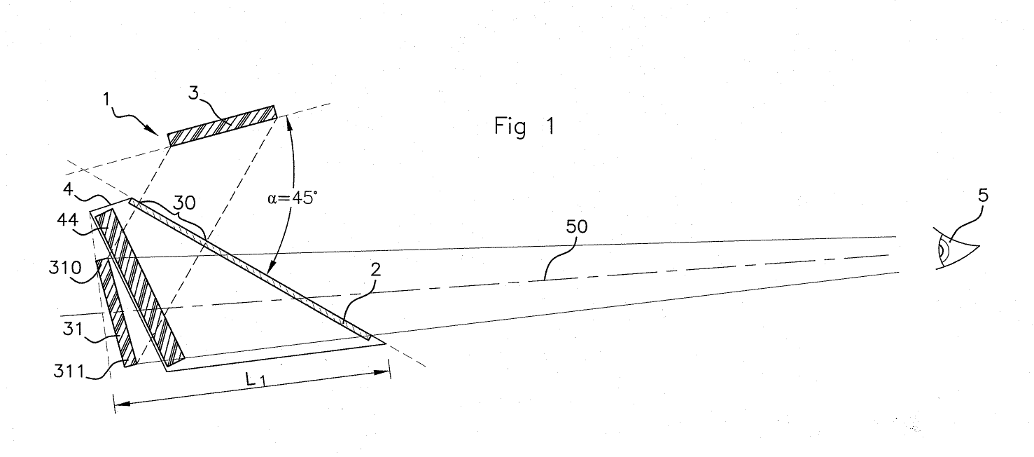

FIG. 1 shows a schematic view of a low-definition display unit according to a conventional construction,

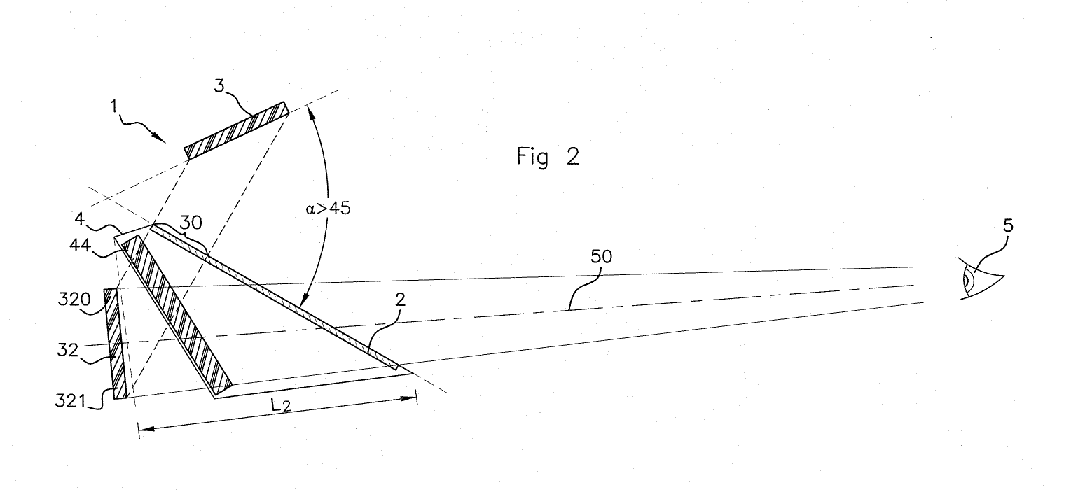

FIG. 2 shows a schematic view of a low-definition display unit according to the invention,

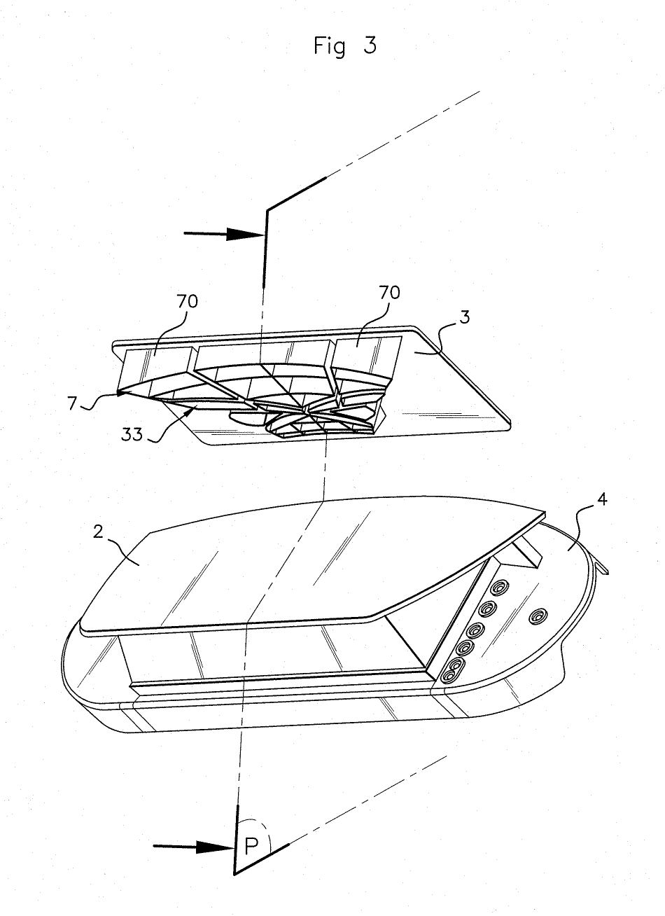

FIG. 3 shows a perspective view of the low-definition display unit according to the invention,

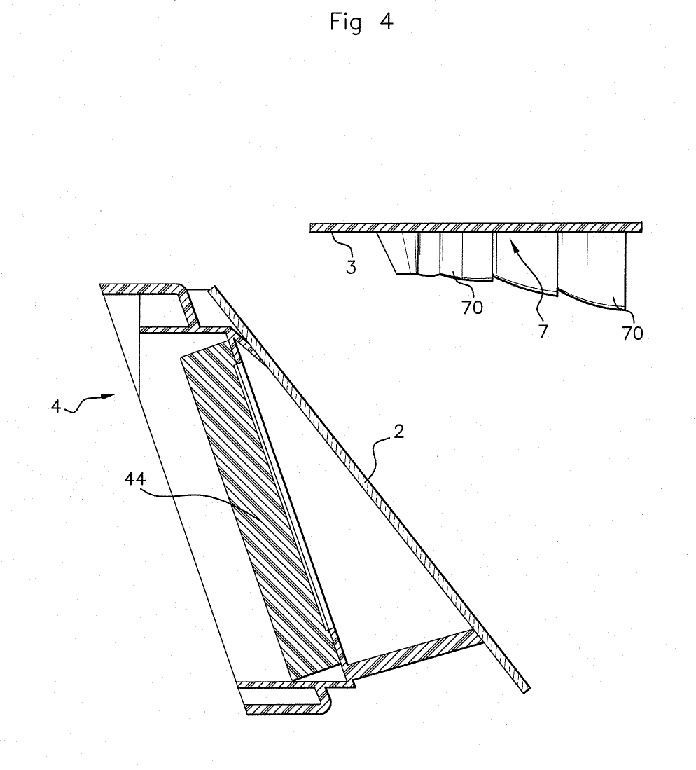

FIG. 4 shows a sectional view of the low-definition display unit according to the invention,

FIG. 5 is a view from below of the low-definition display unit according to the invention, and

FIG. 6 is a front view of the low-definition display unit.

A display device 1, shown in FIG. 1, comprises a semi-transparent mirror 2 and a low-definition display unit 3, the display device 1 being placed in front of an instrument panel 44. The semi-transparent mirror 2 is conventionally placed at an angle a of 45° to the low-definition display unit 3. The low-definition display unit 3 sends an image 30 to the semi-transparent mirror 2, which provides a virtual image 31. In this virtual image, the upper part 310, representing the part of the image 30 that has to appear most distant from the driver, is in fact more distant from said driver's eye 5 than the lower part 311, representing the part of the image 30 that is to appear as the nearest part. The driver's axis of vision 50 corresponds to the axis on which the position of the eyes is located on average, depending on the size of the driver (large or small). This axis of vision 50 is often perpendicular to the dashboard. The display device 1 is integrated with an instrument set 4 which has a considerable length L1 along the axis 50 and is incompatible with the acceptable overall dimensions for this type of display device 1. It is evident from FIG. 1 that the length L1 of the instrument set 4 is greater than the length of the low-definition display device 3. This length L1 is very highly dependent on the length of the semi-transparent mirror 2, which forms the external wall visible to the driver.

A display device 1 according to the invention and its associated instrument set 4 are shown in FIG. 2. The display device 1 comprises a semi-transparent mirror 2 and a low-definition display 3. The semi-transparent mirror 2 is positioned in this case so as to lie at an angle a of more than 45°, and preferably 71°, to the low-definition display unit 3. The display device 1 is placed in front of an instrument panel 44. The low-definition display unit 3 sends an image 30 to the semi-transparent mirror 2, which provides a virtual image 32 in which the upper part 320, representing the part of the image 30 that has to appear most distant from the driver, is in fact nearer to said driver's eye 5 than the lower part 321, representing the part of the image 30 that has to appear as the nearest part. This display device 1 is integrated into the instrument set 4. The latter has a length L2 along the axis 50 which is relatively short and is at least considerably shorter than L1 (see FIG. 1). Evidently, the instrument set 4 of FIG. 2 is shorter than that of FIG. 1, where the length of the instrument set 4 exceeds the length of the low-definition display unit 3, which would make it necessary to increase the length of the instrument set 4 beyond the normal dimensions for this type of product.

This arrangement, in which the part 320 of the image 30 which is supposed to represent the most distant point is nearer to the driver, is unnatural for the eye 5. Surprisingly, however, it has been found that the brain can restore the perspective to the desired position.

FIGS. 3 and 4 show an exemplary embodiment of the display device 1. The low-definition display unit 3 is placed in a shroud 6 (see FIG. 5) placed above the instrument set 4. The shroud 6 has the function of protecting the instrument set 4 from parasitic lights which may appear in the passenger compartment of the vehicle. It is therefore of sufficient size to cover the whole of the instrument set 4.

The low-definition display 3 comprises an LED assembly 7 which forms a parent image 33 (see FIG. 5) which will send the image 30 to the semi-transparent mirror 2. The parent image 33 has a trapezoidal shape (enabling the impression of a three-dimensional appearance of the display to be restored to the eye), composed of a plurality of areas 70 representing certain types of information that are to be displayed. The areas 70 may or may not be illuminated, depending on whether or not information is to be displayed.

The areas 70 comprise one or more LEDs 7, as shown in FIG. 6, which may have different colors so as to be capable of illuminating said area 70 differently.

The areas 70 may also differ from one another in their colors. A single area 70 may also be illuminated with different colors, depending on whether the aim is to alert (red, for example) or to inform (orange or green). For example, it is possible to use RGBW (Red, Green, Blue, White) LEDs, that is to say those having red, green and blue colors plus white, which is difficult to reconstitute from the other colors.

1. A display device (1), associated with an instrument set (4), comprising a low-definition display unit (3) and a semi-transparent mirror (2) placed on a dashboard opposite said low-definition display unit (3), wherein:
the semi-transparent mirror (2) lies at an angle α of more than 45° to the low-definition display unit (3),
the low-definition display unit (3) projects onto the semi-transparent mirror (2) an image (30) of trapezoidal shape, resembling the road in perspective viewed by the driver, and
the image (30) of trapezoidal shape projected onto the semi-transparent mirror (2) provides a virtual image (32) of which the upper part (320), representing the part of the image (30) that has to appear most distant from the driver, is in fact nearer to said driver's eye (5) than the lower part (321) of the virtual image (32), representing the part of the image (30) that has to appear to be the part nearest the driver.

2. The display device (1) as claimed in claim 1, wherein the low-definition display unit (3) has a variable brightness.

3. The display device (1) as claimed in claim 1, wherein the device is placed in front of a steering wheel.

4. The display device (1) as claimed in claim 1, wherein the low-definition display unit (3) is horizontal.

5. The display device (1) as claimed in claim 1, wherein in that the angle (α) between the low-definition display unit (3) and the semi-transparent mirror (2) is 71°.

6. The display device (1) as claimed in claim 1, wherein a multi-function display unit is positioned behind the semi-transparent mirror (2).

7. An instrument set (4) associated with a display device (1) as claimed in claim 1, wherein the semi-transparent mirror (2) forms its outer part visible to the driver.

8. The instrument set (4) associated with a display device (1) as claimed in claim 1, wherein the low-definition display unit (3) is placed in a shroud (6) of said instrument set (4).
